(19) United States
(12) Patent Application Publication
(10) Pub. No.: US 2026/0335776 A1
(43) Pub. Date: Oct. 29, 2026

(54) GAME DEVICE AND PROGRAM

(71) Applicant: Bandai Co., Ltd., Tokyo (JP)

(72) Inventors: Chisato OSHIKIRI, Tokyo (JP); Yuri OKAMOTO, Tokyo (JP); Atsushi YASHIKI, Tokyo (JP)

(21) Appl. No.: 19/460,414

(22) Filed: Jan. 27, 2026

(30) Foreign Application Priority Data
Feb. 7, 2025 (JP) 2025-019637

(51) Int. Cl. A63F 13/825; A63F 13/52; A63F 13/69

(52) U.S. Cl. CPC A63F 13/825; A63F 13/52; A63F 13/69

(57) ABSTRACT

A game apparatus that executes a game in which a plurality of characters having different appearances can emerge includes: an acquisition unit that acquires information regarding another game apparatus; a first identification unit that identifies, from among a plurality of attributes, a first attribute that is an attribute associated with the game apparatus; a second identification unit that identifies, from among the plurality of attributes, a second attribute that is an attribute associated with the another game apparatus; and a determination unit that determines a character to be caused to emerge in the game, in which the determination unit causes a predetermined character to emerge in the game on a condition that the information regarding the another game apparatus associated with the second attribute different from the first attribute is acquired.

### CROSS REFERENCE TO RELATED APPLICATIONS

This application claims priority to Japanese Application No. 2025-019637, filed Feb. 7, 2025, the content of which is hereby incorporated by reference in its entirety.

### BACKGROUND

### Technical Field

The present disclosure relates to a game apparatus and a program, and relates to an electronic game in which a plurality of characters having different appearances can emerge.

### Background Art

In a raising game for raising characters, there is a game apparatus that determines a growth form of a target character from branches of predetermined forms based on a parameter that changes in response to an operation input related to raising (JP Patent No. 6991383 B2).

### BRIEF SUMMARY

Incidentally, in a raising game executed by a game apparatus such as that of Patent Literature 1, all characters that can be raised in the raising game are configured to grow (emerge) through gameplay using the game apparatus alone. Meanwhile, in the configuration, an entertainment value related to character raising ends in a single game apparatus, and thus a user's interest in the game may not continue.

An object of an aspect of the present disclosure is to provide a program, a game apparatus, a display medium, and a game system that provide a play experience with high entertainment value.

One aspect of the present disclosure is a game apparatus that executes a game in which a plurality of characters having different appearances can emerge, the game apparatus including: an acquisition unit that acquires information regarding another game apparatus; a first identification unit that identifies, from among a plurality of attributes, a first attribute that is an attribute associated with the game apparatus; a second identification unit that identifies, from among the plurality of attributes, a second attribute that is an attribute associated with the another game apparatus; and a determination unit that determines a character to be caused to emerge in the game, in which the determination unit causes a predetermined character to emerge in the game on a condition that the information regarding the another game apparatus associated with the second attribute different from the first attribute is acquired.

According to an aspect of the present disclosure, it is possible to provide a play experience with high entertainment value.

### BRIEF DESCRIPTION OF FIGURES

FIG. 1 illustrates an external configuration of a game apparatus according to an embodiment and a modification of an aspect of the present disclosure;

FIG. 2 is a block diagram illustrating a hardware configuration of the game apparatus according to the embodiment and the modification of an aspect of the present disclosure;

FIG. 3 is a flowchart illustrating determination processing executed by the game apparatus according to the embodiment and the modification of an aspect of the present disclosure; and

FIG. 4 illustrates a configuration example of data that is referred to in the game apparatus according to the embodiment and the modification of an aspect of the present disclosure.

### DETAILED DESCRIPTION OF VARIOUS EMBODIMENTS

### Embodiments

Hereinafter, embodiments will be described in detail with reference to the accompanying drawings. Note that the following embodiments do not limit the disclosure according to the claims, and all combinations of features described in the embodiments are not necessarily essential to the disclosure. Two or more features of a plurality of features described in the embodiments may be freely combined. Further, the same or similar components are denoted by the same reference signs, and redundant description will be omitted.

As an embodiment described below, an example will be described in which the present disclosure is applied to a game apparatus that, as an example of a game apparatus, can execute a game that progresses while an appearance of a character changes, that is, a game in which at least one target character exists and an appearance of the target character changes with the progress of the game. However, the present disclosure is applicable to any apparatus capable of executing an electronic game in which a plurality of types of characters having different appearances emerge. That is, it goes without saying that an electronic game to which the present disclosure is applied is not limited to a game of a specific genre such as an evolution game.

A game exemplified in the present embodiment is configured to provide a user with an entertainment experience of growing a target character while sequentially changing an appearance thereof to a different appearance, and, for example, an appearance after growth may be configured to change depending on how the user takes care of the target character. Hereinafter, the game exemplified in the present embodiment will be referred to as an “evolution game” from the viewpoint that the appearance evolves in accordance with growth of the target character.

### <<Configuration of Game Apparatus>>

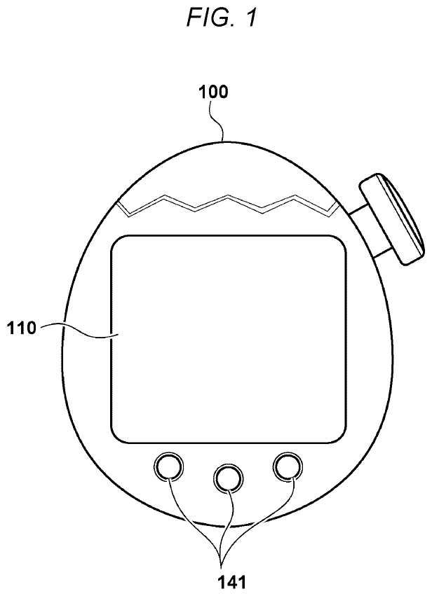

FIG. 1 illustrates an external configuration of a game apparatus 100 according to the present embodiment. In the present embodiment, the game apparatus 100 is configured in a form of a portable toy, and operates using power supplied from a battery or a dry battery (not illustrated). In a mode of operation using a battery, the game apparatus 100 includes a terminal (not illustrated) connectable to a power source, and is configured such that the battery is chargeable by electrically connecting a commercial power source or the like to the terminal via a power supply cable.

### <Hardware Configuration of Game Apparatus>

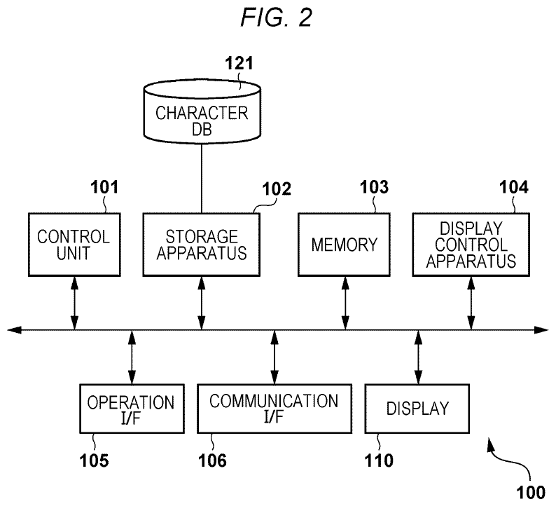

Next, a hardware configuration of the game apparatus 100 will be described with reference to FIG. 2. FIG. 2 is a block diagram illustrating a hardware configuration of the game apparatus 100.

A control unit 101 is a processor such as a central processing unit (CPU), and performs various types of control including operation control of each piece of hardware included in the game apparatus 100. Specifically, for example, the control unit 101 reads a necessary program stored in a storage apparatus 102, deploys the program in a memory 103, and executes the program to perform corresponding control. The control unit 101 further includes a built-in clock and is configured to acquire a current time.

The storage apparatus 102 is an apparatus capable of permanently storing information, such as a nonvolatile memory. The storage apparatus 102 stores, in addition to a program regarding operation of the game apparatus 100 and a program of an evolution game executed in the game apparatus 100, information of parameters necessary for implementing various types of control. In addition, the storage apparatus 102 also functions as a database (character DB 121) of various types of data regarding the evolution game. The memory 103 is a storage apparatus used for temporary data storage, such as a volatile memory. The memory 103 may be used not only as a deployment area for each program but also as a storage area for temporarily storing data and the like output in processes of operation of various types of hardware and various types of control.

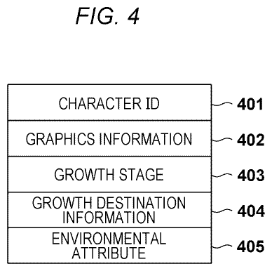

The character DB 121 is a database that manages information regarding characters that can be raised in the evolution game (character information) as a record. In the evolution game executed in the game apparatus 100 according to the present embodiment, the user can raise a character that grows through a plurality of growth stages. The character is configured such that its appearance changes each time the growth stage changes. The character DB 121 manages various types of information as a record for each appearance that can be taken by the character at each growth stage. For example, as illustrated in FIG. 4, character information regarding one record includes, in association with a character ID 401 that uniquely identifies (an appearance of) a character, graphics information 402 for drawing the appearance of the character, a growth stage 403 indicating a growth stage in which the character has the appearance, evolution-destination information 404 indicating an appearance into which the character can grow from the appearance, and an environmental attribute 405 described later in detail. The evolution-destination information 404 may store information of the corresponding character ID 401.

A display control apparatus 104 performs display control such that various screens regarding the evolution game are displayed on a display 110. In the present embodiment, the display control apparatus 104 includes, for example, a drawing apparatus such as a graphics chip or a graphics processing unit (GPU), and also executes drawing processing of generating various screens regarding the evolution game. The display control apparatus 104 includes a drawing memory (not illustrated), deploys various types of graphics data read from the storage apparatus 102, and performs predetermined calculation to generate various images (screens) regarding the evolution game. The screens and the images generated by the display control apparatus 104 are presented to the user by being displayed on, for example, the display 110 included in the game apparatus 100. The display 110 is an apparatus that is included in the game apparatus 100 and displays information, such as a liquid crystal display.

A communication I/F 106 is a communication interface with an external apparatus, which is included in the game apparatus 100. As described above, the game apparatus 100 according to the present embodiment includes a connection terminal (not illustrated), and is configured to be able to perform information communication with another game apparatus 100 by connecting the connection terminals to each other.

An operation I/F 105 is a user interface that is included in the game apparatus 100 and receives an operation input. When it is detected that an operation input has been made, the operation I/F 105 outputs a control signal corresponding to the operation input to the control unit 101. In a mode in which the display 110 is configured to be able to detect a touch input, the operation I/F 105 can include a touch input detection sensor provided in the display 110. In addition, the operation I/F 105 can include, for example, various operation members provided on an exterior of the game apparatus 100.

### <<Overview of Game>>

Hereinafter, an overview of a game in which a play experience is provided in the game apparatus 100 according to the present embodiment will be described. In the present embodiment, the game will be described as an evolution game that provides at least an element for raising a target character as an entertainment element. However, the evolution game is merely one mode of a game in which a plurality of types of characters having different appearances emerge, and implementation of the present disclosure is not limited thereto. The present disclosure is applicable to any game in which a plurality of types of characters having different appearances emerge.

In the evolution game, the user can raise a target character by performing an operation input regarding care for the character. The evolution game starts from hatching an egg, for example, advances a growth stage (progress stage) by sequentially performing operation inputs regarding necessary care, and presents a state in which the target character grows while changing its appearance. The growth stage is, for example, a concept that refers to each stage obtained by dividing a growth process (period) of the target character in the evolution game into a plurality of stages (for example, an egg stage (before birth), a baby stage (infancy), a child stage (childhood), a young stage (adolescent period), and an adult stage (adulthood)), and progresses when a condition such as an elapsed raising time is satisfied.

Here, the character at each growth stage has a predetermined appearance for the growth stage. In other words, in the evolution game according to the present embodiment, an appearance that can be taken by the target character at each growth stage is determined in advance, and for example, which appearance the character grows to have is determined in accordance with a selected egg or a state of care in the growth stages up to that point. As described above, the appearance of the character is determined as the graphics information 402 in the character information registered in the character DB 121. That is, the evolution game is configured such that the appearance of the target character changes to one of a plurality of types of predetermined appearances as raising of the target character progresses.

Each appearance that can be taken by the target character in the evolution game, that is, each of a plurality of types of appearances defined in advance for the evolution game is assigned an individual name, and one appearance can also be regarded as one character having a unique name. That is, each character that can emerge in the evolution game is assigned an individual name, and a change in appearance due to growth of the character can also be regarded as evolution from a character A (name) before growth to a character B (name) after growth. By, for example, obtaining a new egg, the user can repeatedly play the evolution game in which a character that emerges as a result of hatching the egg is set as a target character, and, in the process, the target character can “evolve into a specific character”. Therefore, in the following description, “a change of an appearance of a target character to an appearance of a specific character” may be simply referred to as “evolving into a specific character”.

That is, the evolution game described in the present embodiment presents a state in which an appearance of a target character changes due to evolution, and thus, in a case where evolution occurs, an evolved character having a different appearance is configured to emerge instead of the target character before evolution, and to become a control target as a new target character.

Regarding a state of change in appearance of the character at a growth stage in the evolution game, in order to ensure a strategic property, a lineage of evolution is defined such that the character evolves into a character having an identical appearance under identical conditions in repeated game play. That is, information indicating which character's appearance the target character is to have due to its evolution is defined as an “evolution-destination branch” defined for each character at an arbitrary growth stage. In the evolution game according to the present embodiment, for each character defined from the baby stage to the young stage, one or more characters are defined as characters into which the character is evolved with a change in appearance.

In the evolution game according to the present embodiment, an evolution destination of the target character when the growth stage progresses is determined at least based on information regarding an attribute associated with the target character in the process of the evolution game. The present embodiment will be described by using, as an example of such an attribute, an environmental attribute associated with an environment (area) in the evolution game.

In the evolution game according to the present embodiment, a plurality of types of areas are provided. The plurality of types of areas are associated with different environmental attributes, and, for example, not only a background image displayed when the target character is placed in the area but also an item obtainable in the area, an event that occurs in the area, and the like are configured to be different. In the example described below, description will be made on the assumption that areas (a plain area, a seaside area, and a highland area) having three types of environmental attributes of land, water, and sky are provided in the evolution game. When the target character is placed in the area by the user's operation and a condition is satisfied, the environmental attribute of the area is associated with the target character.

Here, some of a plurality of types of characters that can emerge in the evolution game are associated with one of the above three types of environmental attributes. Information regarding the environmental attribute associated with the character is included in, for example, the environmental attribute 405 of the character information that is managed for each character in the character DB 121. That is, for the character associated with the environmental attribute, for example, information for uniquely identifying the environmental attribute is stored in the environmental attribute 405 of the character information regarding the character. Meanwhile, among the plurality of types of characters that can emerge in the evolution game, for a character associated with no environmental attribute, information indicating any environmental attribute is not stored (is blank) in the environmental attribute 405 of the character information regarding the character.

A state in which any environmental attribute is associated with the character may be referred to, for example, in determination of a behavioral characteristic of the character. Such a behavioral characteristic can include, for example, emerging only in the area of the associated environmental attribute, preferring to be in the area of the associated environmental attribute, and preferring an item acquired in the area of the associated environmental attribute. Therefore, in a case where the target character evolves into a character associated with one environmental attribute, that is, in a case where the appearance of the target character becomes an appearance of a character associated with the environmental attribute, one environmental attribute is associated with the target character. In other words, in a case where one environmental attribute is associated with the target character, a character determined as an appearance of an evolution destination is a character of the corresponding growth stage associated with the environmental attribute.

For example, because the target character is not associated with any attribute yet at the baby stage, the target character emerges as a character having a common appearance. Thereafter, when the target character stays in any area for a predetermined time at the baby stage, an environmental attribute of the area is associated with the target character, and the target character evolves into a character at the child stage associated with the environmental attribute. In a case where a predetermined evolution condition is satisfied at the child stage, the target character evolves into a character at the young stage associated with the same environmental attribute as that at the child stage. Similarly, in a case where a predetermined evolution condition is satisfied at the young stage, the target character evolves into a character at the adult stage associated with the same environmental attribute as that at the young stage.

Therefore, in the evolution game according to the present embodiment, when the target character proceeds from the baby stage associated with no environmental attribute to the child stage, the target character evolves into a character having an environmental attribute different from a currently associated environmental attribute (no association). Meanwhile, after the child stage, the character is controlled so as to evolve only into a character having the same environmental attribute as the currently associated environmental attribute, that is, so as not to evolve into a character having an environmental attribute different from the currently associated environmental attribute. That is, association of the environmental attribute with the target character is performed only at the baby stage, and after the child stage, the target character evolves into a character having the associated environmental attribute, and does not evolve into a character having another environmental attribute.

Note that, if a direction of subsequent evolution is determined by behavior at the baby stage, the user's interest in the evolution game may be reduced. In particular, in a mode in which a time limit is provided at the baby stage, in a case where the target character evolves into the child stage, a desired environmental attribute may not be associated with the target character, and may become a character having another environmental attribute. Therefore, association of the environmental attribute with the target character may be configured to be possible also at the child stage. That is, the evolution game may be configured such that the target character can be changed to a character having another environmental attribute during the child stage by, also at the child stage, placing the target character in an area different from that of the environmental attribute currently associated with the target character and causing the target character to stay in the area for a predetermined time.

### <Special Evolution>

In the evolution game in which the lineage of the evolution destination is determined in advance as described above, the user can easily raise all types of characters by repeatedly playing the game. As a result, some users may be less interested in the evolution game.

Therefore, in the evolution game according to the present embodiment, a predetermined character among the characters that can emerge is defined as a special character, and is configured such that an emergence condition (evolution condition) thereof is not satisfied when the game is played by the game apparatus 100 alone. Specifically, the special character is configured such that the emergence condition is satisfied on a condition that at least communication with another game apparatus 100 has been performed.

A communication element with the another game apparatus 100 in the evolution game may be any element, such as, for example, interacting with a character being raised in the another game apparatus 100 (hereinafter, referred to as another character), another character visiting, the target character being raised in the game apparatus 100 (hereinafter, also referred to as an own character) performing a cooperative work with another character, or the own character and another character competing with each other, but may be configured to provide the user with more entertainment elements than in a case where the game is played by the game apparatus 100 alone. That is, guiding the user to actively use the communication element with the another game apparatus 100 makes it possible to maintain the user's interest in the evolution game. Therefore, in the evolution game according to the present embodiment, a special character whose emergence condition is satisfied under a condition of communication with the another game apparatus 100 is provided.

In particular, in a case where the communication element includes a function of transferring an item (for example, a harvested fruit) obtained in an environment in the evolution game executed by one game apparatus 100 through interaction between the own character and another character, the entertainment value tends to be higher when environments in the evolution game differ between the game apparatuses 100. Specifically, it is considered that the user can obtain a higher entertainment experience when an item that cannot be obtained or is difficult to obtain in the environment in the evolution game executed by his/her own game apparatus 100 is transferred, rather than when an item that can also be obtained in the environment is transferred. That is, it is considered that recommending use of the communication element between the game apparatuses 100 that execute the evolution game in different environments makes it easier to enhance and maintain the user's interest in the evolution game.

Therefore, in the evolution game according to the present embodiment, the emergence condition of the special character is set as follows.

First, one of a plurality of types of attributes is associated with each game apparatus 100. Which attribute is associated with the game apparatus 100 may be configured to be identifiable by referring to, for example, attribute information permanently held in the storage apparatus 102 of the game apparatus. That is, the control unit 101 of the game apparatus 100 can identify an attribute associated with the own apparatus by referring to the attribute information. During communication with another game apparatus 100, the control unit 101 of the game apparatus 100 can identify an attribute associated with the another game apparatus 100 serving as a communication destination by making a transmission request and referring to attribute information acquired from the another game apparatus 100. Association of an attribute with each game apparatus 100 is performed, for example, before shipment of the game apparatus 100. Then, the attribute associated with the game apparatus 100 does not change with the progress of the evolution game, and is fixedly defined for the game apparatus 100. That is, the attribute information stored in the storage apparatus 102 is held without being changed.

In the present embodiment, the attribute associated with each game apparatus 100 is one of a plurality of types of environmental attributes. That is, in the present embodiment, the game apparatus 100 includes the game apparatus 100 associated with a land attribute, the game apparatus 100 associated with a water attribute, and the game apparatus 100 associated with a sky attribute. The environmental attribute associated with the game apparatus 100 defines an element that is initially unlocked in the evolution game executed in the game apparatus 100.

Here, the element that is initially unlocked is configured to differ depending on which environmental attribute is associated with the game apparatus 100. For example, in the evolution game executed by the game apparatus 100 associated with the land attribute, at an initial stage (at the time of first activation), there is a difference in play experience provided between the environmental attributes, such as an area corresponding to the land attribute being wider than areas of the other environmental attributes, facilities being sufficiently provided, and items of the land attribute being easily obtained. Therefore, between the game apparatuses 100 associated with different environmental attributes, there is a difference in environment in the evolution game from the viewpoint that initially unlocked elements are different, and it is possible to provide a play experience with high entertainment value in a case where communication is performed.

Accordingly, in the evolution game according to the present embodiment, the emergence condition of the special character includes, as a condition, communication with the game apparatus 100 associated with an environmental attribute different from that of the own apparatus.

As described above, in the evolution game executed by the game apparatus 100, the area of the environmental attribute associated with the own apparatus (hereinafter, also referred to as an own environmental attribute) is initially well provided, and thus the user can easily grasp that an initial state of the evolution game is specialized in the area. That is, the user who uses the game apparatus 100 can grasp which one of the land attribute, the water attribute, and the sky attribute the game apparatus 100 is specialized in at a start point of the game. Such a difference in the environmental attribute associated with the game apparatus 100 may be grasped by the user at a time of purchase by providing and distributing a lineup of the land attribute, the water attribute, and the sky attribute at a time of sale of the game apparatus 100. The game apparatuses 100 having those different environmental attributes may be configured such that a difference in the associated environmental attribute can be determined without checking a screen of the evolution game to be executed, for example, by differing in colors or shapes of main bodies (housings) of the game apparatuses 100. Therefore, in order to more effectively show characteristics of the game apparatus 100 based on the associated environmental attribute, the special character that emerges in one game apparatus 100 is a character associated with the same environmental attribute as the environmental attribute associated with the game apparatus 100. With such a configuration, it is possible to provide, for each game apparatus 100, an entertainment element in which the special character having a characteristic linked to the evolution game executed in the game apparatus 100 emerges.

In other words, because the special character based on unique attribute information associated with the game apparatus 100 emerges, the characters that can emerge in the evolution game include a special character having each environmental attribute. Meanwhile, the special character that emerges in the evolution game executed in the game apparatus 100 is limited to a character associated with the own environmental attribute, and thus a special character associated with an environmental attribute different from the own environmental attribute (another environmental attribute) is controlled so as not to emerge in the evolution game executed in the game apparatus 100. In other words, in the evolution game executed in one game apparatus 100, among the plurality of types of characters that can emerge in the evolution game, characters other than special characters having other environmental attributes are controlled to emerge.

Note that, for each of the characters other than the special characters among the plurality of types of characters that can emerge in the evolution game, not only an evolution-destination branch but also an emergence condition to be achieved to cause the character to emerge in the evolution game is set. Such an emergence condition is configured not to require communication with another game apparatus 100. Meanwhile, in a game such as the evolution game in which the target character evolves into a character having a new appearance as the growth stage of the target character progresses, if a special character is not caused to emerge even though an emergence condition of the special character is satisfied on the ground that an emergence condition regarding another character has been achieved, an entertainment element regarding the special character that emerges under a limited condition cannot be provided to the user. Therefore, in a case where the emergence condition of the special character is satisfied by communication with another game apparatus 100 associated with another environmental attribute, the special character is controlled to emerge in preference to another character other than the special character, even if an emergence condition of the another character is satisfied.

Further, in order to improve an entertainment value regarding communication between the game apparatuses 100, the emergence condition of the special character may be configured to include, as a condition, communication with two or more other game apparatuses 100 associated with different other environmental attributes. That is, if communication with another game apparatus 100 having another type of environmental attribute is only required, the emergence condition can be easily achieved, and thus, by configuring communication to be performed with other game apparatuses 100 having two or more types of other environmental attributes, it is possible to guide the user to a situation in which the user can more easily experience the entertainment element regarding communication between the game apparatuses 100.

The emergence condition of the special character may include emergence of a character associated with the own environmental attribute in the game. For example, in a game such as the evolution game in which the target character grows while evolving and changing its appearance, characters associated with various environmental attributes can emerge in the game. However, if a character having another environmental attribute evolves into a special character having the own environmental attribute, there is no linkage in the evolution, and a suitable entertainment experience may not be ensured, for example, the worldview of the evolution game may collapse. Therefore, the evolution game according to the present embodiment may be controlled to include a condition that the target character before evolution into a special character is a character associated with the own environmental attribute. In the evolution game according to the present embodiment, the special character is described as being configured to be able to emerge as a character at the adult stage. In this case, in order to evolve the target character into a special character at the adult stage, it is necessary to associate the own environmental attribute with the target character at the baby stage and to cause the target character to evolve into a character associated with the own environmental attribute at the child stage and the young stage.

As described above, in the evolution game according to the present embodiment, the special character is controlled to emerge as an evolution to the adult stage on a condition that communication with two other game apparatuses 100 associated with different other environmental attributes has been performed at the young stage. However, implementation of the present disclosure is not limited thereto, and communication with other game apparatuses 100 associated with other environmental attributes may be performed at stages other than the young stage immediately before the adult stage. In this case, information regarding environmental attributes associated with communication partners may be held for communication with the other game apparatuses 100 performed up to the young stage, and, at a timing at which the target character evolves to the adult stage, whether or not the target character evolves into a special character may be determined based on the information.

### <<Determination Processing>>

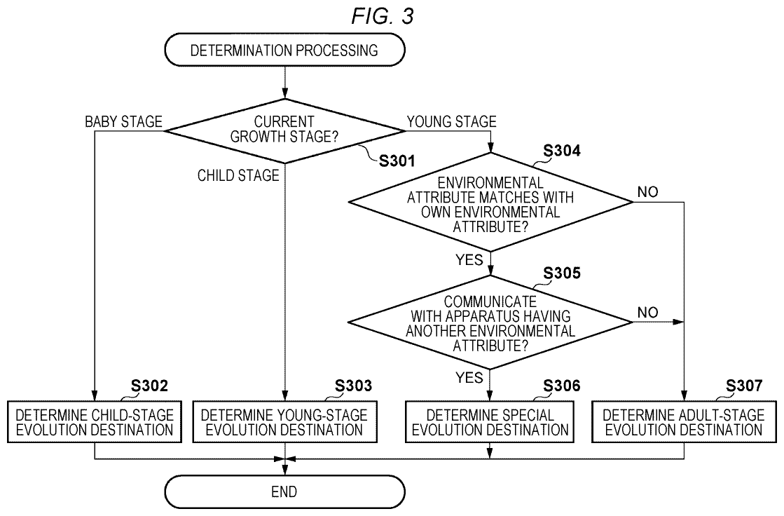

Hereinafter, specific processing of accumulation processing executed in the game apparatus 100 according to the present embodiment in relation to accumulation of various icons will be described with reference to a flowchart of FIG. 3. The processing corresponding to the flowchart can be implemented by the control unit 101, for example, reading a corresponding processing program stored in the storage apparatus 102, deploying the processing program in the memory 103, and executing the processing program. Note that the present determination processing will be described as being started, for example, when an evolution condition for the target character is satisfied.

In step S301, the control unit 101 determines a current growth stage of the target character. The control unit 101 proceeds to S302 if the current growth stage of the target character is the baby stage, the control unit 101 proceeds to S303 if the current growth stage thereof is the child stage, and the control unit 101 proceeds to S304 if the current growth stage thereof is the young stage.

In S302, the control unit 101 determines, as an evolution destination of the target character at the child stage, a character having an environmental attribute associated with the target character and provided in relation to the child stage, and completes the present determination processing.

Meanwhile, if it is determined in S301 that the current growth stage of the target character is the child stage, the control unit 101 determines, in S303, among characters at evolution-destination branches defined for a character corresponding to a current appearance of the target character, a character that satisfies an emergence condition as an evolution destination of the target character at the young stage, and completes the present determination processing.

Meanwhile, if it is determined in S301 that the current growth stage of the target character is the young stage, the control unit 101 determines in S304 whether or not the environmental attribute associated with the target character matches with the own environmental attribute. If the control unit 101 determines that the environmental attribute associated with the target character matches with the own environmental attribute, the processing proceeds to S305, and if not, the processing proceeds to S307.

In S305, the control unit 101 determines whether or not communication with two types of other game apparatuses 100 associated with different other environmental attributes has been performed during the young stage. If the control unit 101 determines that communication with two types of other game apparatuses 100 associated with different other environmental attributes has been performed during the young stage, the processing proceeds to S306, and if not, the processing proceeds to S307.

In S306, the control unit 101 determines a special character associated with the own environmental attribute as an evolution destination of the target character at the adult stage, and completes the present determination processing.

Meanwhile, if it is determined in S304 that the environmental attribute associated with the target character does not match with the own environmental attribute, or if it is determined in S305 that communication with two types of other game apparatuses 100 associated with different other environmental attributes has not been performed during the young stage, the control unit 101 determines, in S307, among characters at evolution-destination branches defined for a character corresponding to the current appearance of the target character, a character that satisfies an emergence condition as an evolution destination of the target character at the adult stage, and completes the present determination processing.

As described above, according to the game apparatus of the present embodiment, it is possible to provide a play experience with high entertainment value.

### Modification 1

In the above embodiment, a mode in which the environmental attribute associated with the area in the evolution game is associated with the game apparatus 100 has been described in consideration of affinity with contents of the evolution game and an entertainment element provided through the evolution game, but implementation of the present disclosure is not limited thereto. For example, it goes without saying that the present disclosure can be implemented in a mode in which other attributes are associated with the game apparatus 100, such as different attributes provided in the evolution game, other types of attributes associated with characters that can emerge, an attribute regarding the type of the evolution game, or an attribute simply regarding a release timing of the game apparatus 100.

### Modification 2

In the embodiment and the modification described above, a game executed in the game apparatus 100 has been described as the evolution game that progresses while changing the appearance of the target character, but implementation of the present disclosure is not limited thereto. The present disclosure can include an electronic game in which characters having different appearances sequentially emerge instead of the same target character. That is, it goes without saying that an electronic game to which the present disclosure is applied is not limited to a game of a specific genre such as an evolution game.

### Modification 3

In the embodiment and the modifications described above, a mode has been described in which communication between the game apparatus 100 and another game apparatus 100 is performed by connecting connection terminals included in these apparatuses, but implementation of the present disclosure is not limited thereto. Communication between the game apparatuses 100 can include, for example, a mode in which these apparatuses are connected to each other via an arbitrary cable, a mode in which the apparatuses are directly wirelessly connected to each other using short-range wireless communication, a mode in which the apparatuses are wirelessly connected to each other via an arbitrary relay apparatus such as an access point, and a mode in which the apparatuses perform communication connection via an arbitrary external apparatus (such as a server) connected through a given network.

In addition, a method of acquiring information regarding an attribute associated with another game apparatus 100 does not require information communication between the game apparatuses 100, and may be performed, for example, by the game apparatus 100 capturing an image of code information or the like displayed on the display 110 of the another game apparatus 100, by an arbitrary imaging apparatus capturing an image and transmitting corresponding information to the game apparatus 100, or by the user directly inputting the information in the game apparatus 100. That is, the present disclosure can be implemented as long as the game apparatus 100 acquires information regarding the another game apparatus 100 (including information regarding an attribute associated with the another game apparatus 100).

### Other Embodiments

The disclosure is not limited to the above-described embodiment, and various modifications and changes can be made within the scope of the gist of the disclosure.

### Summary of Embodiments

The above embodiment discloses at least the following game apparatus and program.
(1) A game apparatus that executes a game in which a plurality of characters having different appearances can emerge, the game apparatus including:
an acquisition unit that acquires information regarding another game apparatus;
a first identification unit that identifies, from among a plurality of attributes, a first attribute that is an attribute associated with the game apparatus;
a second identification unit that identifies, from among the plurality of attributes, a second attribute that is an attribute associated with the another game apparatus; and
a determination unit that determines a character to be caused to emerge in the game, in which
the determination unit causes a predetermined character to emerge in the game on a condition that the information regarding the another game apparatus associated with the second attribute different from the first attribute is acquired.
(2) The game apparatus according to (1), in which:
one or more of the characters that can emerge in the game are associated with one of the plurality of attributes; and
the predetermined character is a character associated with the first attribute.
(3) The game apparatus according to (1) or (2), in which:
the predetermined character is provided for each of the plurality of attributes in the game; and
the predetermined character provided for an attribute different from the first attribute does not emerge in the game executed in the game apparatus.
(4) The game apparatus according to (3), in which
among characters provided for attributes different from the first attribute, a character other than the predetermined character is configured to be able to emerge in the game executed in the game apparatus.
(5) The game apparatus according to any one of (1) to (4), in which:
an emergence condition to be achieved in order for each character other than the predetermined character among the plurality of characters to emerge in the game is defined; and
the determination unit causes the predetermined character to emerge in the game in preference to a character whose emergence condition is achieved on a condition that the information regarding the another game apparatus associated with the second attribute different from the first attribute is acquired.
(6) The game apparatus according to any one of (1) to (5), in which:
the plurality of attributes includes at least three types of attributes; and
the determination unit causes the predetermined character to emerge in the game on a condition that information regarding other game apparatuses associated with two or more types of the second attributes different from the first attribute is acquired.
(7) The game apparatus according to any one of (1) to (6), in which:
one or more of the plurality of characters are associated with one of the plurality of attributes; and
the determination unit causes the predetermined character to emerge in the game on a condition that at least a character associated with the first attribute emerges in the game.
(8) The game apparatus according to (7), in which:
the game is a game that progresses in stages; and
the determination unit
   at a first progress stage in the game, causes a character associated with an attribute different from an attribute of a character currently emerging in the game to emerge in the game, and
   at a second progress stage different from the first progress stage in the game, does not cause a character associated with an attribute different from the attribute of the character currently emerging in the game to emerge in the game.
(9) The game apparatus according to any one of (1) to (8), in which
the first attribute is fixedly associated with the game apparatus and does not change with the progress of the game.
(10) The game apparatus according to any one of (1) to (9), in which
the first attribute is used to determine an element that is initially unlocked in the game executed in the game apparatus.
(11) The game apparatus according to any one of (1) to (10), in which
the game apparatus associated with the first attribute and the another game apparatus associated with the second attribute different from the first attribute have different appearances of an apparatus main body.
(12) The game apparatus according to any one of (1) to (11), in which:
the game is a game that progresses in stages while an appearance of a character changes; and
the character to be caused to emerge, which is determined by the determination unit, emerges in the game instead of a character currently emerging in the game.
(13) The game apparatus according to (12), in which
the determination unit causes the predetermined character to emerge in the game on a condition that the information regarding the another game apparatus associated with the second attribute different from the first attribute is acquired at a predetermined progress stage in the game.
(14) A program for causing a computer that executes a game in which a plurality of characters having different appearances can emerge to execute:
acquisition processing of acquiring information regarding another computer;
first identification processing of identifying, from among a plurality of attributes, a first attribute that is an attribute associated with the computer;
second identification processing of identifying, from among the plurality of attributes, a second attribute that is an attribute associated with the another computer; and
determination processing of determining a character to be caused to emerge in the game, in which
in the determination processing, a predetermined character is caused to emerge in the game on a condition that the information regarding the another computer associated with the second attribute different from the first attribute is acquired.

1. A game apparatus that executes a game in which a plurality of characters having different appearances can emerge, the game apparatus comprising:
an acquisition unit that acquires information regarding another game apparatus;
a first identification unit that identifies, from among a plurality of attributes, a first attribute that is an attribute associated with the game apparatus;
a second identification unit that identifies, from among the plurality of attributes, a second attribute that is an attribute associated with the another game apparatus; and
a determination unit that determines a character to be caused to emerge in the game, wherein
the determination unit causes a predetermined character to emerge in the game on a condition that the information regarding the another game apparatus associated with the second attribute different from the first attribute is acquired.

2. The game apparatus according to claim 1, wherein:
one or more of the characters that can emerge in the game are associated with one of the plurality of attributes; and
the predetermined character is a character associated with the first attribute.

3. The game apparatus according to claim 1, wherein:
the predetermined character is provided for each of the plurality of attributes in the game; and
the predetermined character provided for an attribute different from the first attribute does not emerge in the game executed in the game apparatus.

4. The game apparatus according to claim 3, wherein
among characters provided for attributes different from the first attribute, a character other than the predetermined character is configured to be able to emerge in the game executed in the game apparatus.

5. The game apparatus according to claim 1, wherein:
an emergence condition to be achieved in order for each character other than the predetermined character among the plurality of characters to emerge in the game is defined; and
the determination unit causes the predetermined character to emerge in the game in preference to a character whose emergence condition is achieved on a condition that the information regarding the another game apparatus associated with the second attribute different from the first attribute is acquired.

6. The game apparatus according to claim 1, wherein:
the plurality of attributes includes at least three types of attributes; and
the determination unit causes the predetermined character to emerge in the game on a condition that information regarding other game apparatuses associated with two or more types of the second attributes different from the first attribute is acquired.

7. The game apparatus according to claim 1, wherein:
one or more of the plurality of characters are associated with one of the plurality of attributes; and
the determination unit causes the predetermined character to emerge in the game on a condition that at least a character associated with the first attribute emerges in the game.

8. The game apparatus according to claim 7, wherein:
the game is a game that progresses in stages; and
the determination unit
at a first progress stage in the game, causes a character associated with an attribute different from an attribute of a character currently emerging in the game to emerge in the game, and
at a second progress stage different from the first progress stage in the game, does not cause a character associated with an attribute different from the attribute of the character currently emerging in the game to emerge in the game.

9. The game apparatus according to claim 1, wherein
the first attribute is fixedly associated with the game apparatus and does not change with the progress of the game.

10. The game apparatus according to claim 1, wherein
the first attribute is used to determine an element that is initially unlocked in the game executed in the game apparatus.

11. The game apparatus according to claim 1, wherein
the game apparatus associated with the first attribute and the another game apparatus associated with the second attribute different from the first attribute have different appearances of an apparatus main body.

12. The game apparatus according to claim 1, wherein:
the game is a game that progresses in stages while an appearance of a character changes; and
the character to be caused to emerge, which is determined by the determination unit, emerges in the game instead of a character currently emerging in the game.

13. The game apparatus according to claim 12, wherein
the determination unit causes the predetermined character to emerge in the game on a condition that the information regarding the another game apparatus associated with the second attribute different from the first attribute is acquired at a predetermined progress stage in the game.

14. A non-transitory computer-readable storage medium storing thereon a program for causing a computer to execute a game in which a plurality of characters having different appearances can emerge to execute:
acquisition processing of acquiring information regarding another computer;
first identification processing of identifying, from among a plurality of attributes, a first attribute that is an attribute associated with the computer;
second identification processing of identifying, from among the plurality of attributes, a second attribute that is an attribute associated with the another computer; and
determination processing of determining a character to be caused to emerge in the game, wherein
in the determination processing, a predetermined character is caused to emerge in the game on a condition that the information regarding the another computer associated with the second attribute different from the first attribute is acquired.
